(19) United States
(12) Patent Application Publication
(10) Pub. No.: US 2010/0183076 A1
(43) Pub. Date: Jul. 22, 2010

(54) Encoding Images

(75) Inventor: Ki Wook Yoon, Seoul (KR)

Correspondence Address: FISH & RICHARDSON, PC, P.O. BOX 1022, MINNEAPOLIS, MN, 55440-1022, US

(73) Assignee: CORE LOGIC, INC., Seoul (KR)

(21) Appl. No.: 12/692,540

(22) Filed: Jan. 22, 2010

(30) Foreign Application Priority Data
Jan. 22, 2009 (KR) 10-2009-0005561

(51) Int. Cl. H04N 7/26

(52) U.S. Cl. 375/240.16; 375/E07.125

(57) ABSTRACT

Techniques, apparatus and computer readable storage media are described for encoding images in a video. In one aspect, a method performed by an encoding device to encode a video is described. The method includes sequentially performing a motion estimation operation and an encoding operation, which includes determining an operation mode of the motion estimation operation based on a quantity of calculations for the encoding operation. Sequentially performing a motion estimation operation and an encoding operation include performing the motion estimation operation with respect to an image of the video based on the determined operation mode. Additionally, sequentially performing a motion estimation operation and an encoding operation includes performing the encoding operation based on a result of the motion estimation operation.

### CROSS-REFERENCE TO RELATED PATENT APPLICATION

This application claims the benefit of Korean Patent Application No. 10-2009-0005561, filed on Jan. 22, 2009, in the Korean Intellectual Property Office, the disclosure of which is incorporated herein in its entirety by reference.

### BACKGROUND

This disclosure relates to encoding images in video data.

In video compression methods such as Motion Picture Expert Group-1 (MPEG-1), MPEG-2, and MPEG-4H.264/MPEG-4 advanced video coding (AVC), a picture or image in a motion picture or video is first divided into predetermined image units, such as macroblocks. Each of the image units is encoded using inter-prediction or intra-prediction.

Using inter-prediction, images in a video can be compressed by removing chronological duplications among the images. An example of inter-prediction includes motion estimation encoding. Motion estimation encoding can be used to encode images by predicting the motion of a current block based on at least one reference image and performing motion compensation according to a result of the prediction. In motion estimation encoding, a reference block, which is most similar to a current block, is found within a predetermined range for searching for reference pictures by using a predetermined examining function. A block exhibiting the smallest sum of absolute differences (SAD) with respect to a current block is found as a reference block. The reference block becomes the inter-prediction block of a current block, and a data compression ratio may be improved by encoding and transmitting only a residual block, which is a current block minus a reference block. For example, the current block may be a block of various sizes (e.g. 16×16 blocks, 8×16 blocks, 16×8 blocks, 8×8 blocks, and 4×4 blocks).

### SUMMARY

The specification describes a method and an apparatus of encoding an image, which can adaptively determine an operation mode of a motion estimation operation based on an operating status of an image encoding unit.

In one aspect, a method performed by an image encoding device to encode a video is described. The method includes sequentially performing a motion estimation operation and an encoding operation, which includes determining an operation mode of the motion estimation operation based on a quantity of calculations for the encoding operation. Sequentially performing a motion estimation operation and an encoding operation include performing the motion estimation operation with respect to an image of the video based on the determined operation mode. Additionally, sequentially performing a motion estimation operation and an encoding operation includes performing the encoding operation based on a result of the motion estimation operation.

Implementations can optionally include one or more of the following limitations. The operation mode of the motion estimation operation can be adaptively determined from among multiple different operation modes corresponding to different complexities of the motion estimation operation based on the quantity of calculations for the encoding operation. The method can include buffering the result of the motion estimation operation. The encoding operation can be performed based on the buffered result of the motion estimation operation. Determining the operation mode can include determining the quantity of calculations for the encoding operation based on a quantity of the buffered result of the motion estimation operation, and adaptively selecting the operation mode from among a plurality of different operation modes based on a complexity of the motion estimation operation. Determining the quantity of calculations for the encoding operation based on the quantity of the buffered result of the motion estimation operation can include determining whether the quantity of the buffered result of the motion estimation operation is equal to or greater than a first threshold value; and when determined that the quantity of the buffered result of the motion estimation operation is smaller than the first threshold value, determining whether the quantity of the buffered result of the motion estimation operation is smaller than or equal to a second threshold value. The second threshold value can be smaller than the first threshold value.

Implementations can optionally include one or more of the following features. Adaptively determining the operation mode can include selecting a first operation mode from the multiple different operation modes as the operation mode of the motion estimation operation when the quantity of the buffered result of the motion estimation operation is equal to or greater than the second threshold value and is smaller than the first threshold value. Also, a second operation mode can be selected from the multiple different operation modes as the operation mode of the motion estimation operation when the quantity of the buffered result of the motion estimation operation is smaller than the second threshold value. Additionally, a third operation mode can be selected from the multiple different operation modes as the operation mode of the motion estimation operation when the quantity of the buffered result of the motion estimation operation is equal to or greater than the first threshold value. The complexity of the motion estimation operation in the first operation mode can be higher than the complexity of the motion estimation operation in the second operation mode and lower than the complexity of the motion estimation operation in the third operation mode. The encoding operation can be performed with respect to a previous image of the video while the motion estimation operation can be performed with respect to a current image of the video in parallel.

In another aspect, a computer readable storage medium can embody instructions to cause a data processing to perform operations described in the method.

In another aspect, an image encoding device can include a motion estimation unit to perform a motion estimation operation with respect to an image in a given video; and an encoding unit to perform an encoding operation based on a result of the motion estimation operation. The motion estimation unit determines an operation mode of the motion estimation unit based on a quantity of calculations performed by the encoding unit during the encoding operation and performs the motion estimation operation with respect to the image according to the determined operation mode.

Implementations can optionally include one or more of the following features. The motion estimation unit can adaptively determine the operation mode from among a plurality of different operation modes based on a complexity of the motion estimation operation. The image encoding device can further include a buffer for temporarily storing a result of the motion estimation operation. The encoding unit can perform the encoding operation based on the buffered result of the motion estimation operation. The motion estimation unit can include a buffer status detection unit to determine the quantity of calculations performed by the encoding unit during the encoding operation based on a quantity of data stored in the buffer. The motion estimation unit can include an operation mode determining unit to adaptively determine the operation mode from among a plurality of different operation modes based on the complexity of the motion estimation operation. Additionally, the motion estimation unit can include a motion estimation operation unit to perform the motion estimation operation with respect to the image according to the determined operation mode. The buffer status detection unit can determine whether the quantity of the data stored in the buffer is equal to or greater than a first threshold value or not. When determined that the quantity of data stored in the buffer is equal to or greater than the first threshold number, the buffer status detection unit determines whether the quantity of data stored in the buffer is equal to or greater than a second threshold value, wherein the second threshold value is smaller than the first threshold value.

Implementations can optionally include at least one of the following features. The operation mode determination unit can select a first operation mode from the multiple different operation modes as the operation mode of the motion estimation operation when the quantity of data stored in the buffer is equal to or greater than the second threshold value and is smaller than the first threshold value. The operation mode determination unit can determine a second operation mode from the multiple different operation modes as the operation mode of the motion estimation operation when the quantity of data stored in the buffer is smaller than the second threshold value. The operation mode determination unit can determine a third operation mode from the multiple different operation modes as the operation mode of the motion estimation operation when the quantity of data stored in the buffer is equal to or greater than the first threshold value. The complexity of the motion estimation operation in the first operation mode can be higher than the complexity of the motion estimation operation in the second operation mode and lower than the complexity of the motion estimation operation in the third operation mode. The encoding unit can perform the encoding operation with respect to a previous image of the given video while the motion estimation unit performs the motion estimation operation with respect to a current image of the given video in parallel.

The described techniques, apparatus and computer readable storage medium can potentially provide one or more of the following advantages. For example, the motion estimation operation and the remaining operations can be performed in parallel. An algorithm for a motion estimation operation unit can be selected, such that the total quantity of calculations of the motion estimation operating unit and the sum of the quantities of calculations for the remaining operations are similar to each other. Also, an operation mode of a motion estimation operation can be adaptively determined according to an operating status of an image encoding unit. For example, the operation mode can be determined according to the quantities of calculations for the remaining operations other than the motion estimation operation. Thus, the quantities of calculations between the motion estimation operation and the remaining operations may be uniformly distributed. Accordingly, the delay times may not occur when the motion estimation operation and the remaining operations are performed in parallel, which can enhance the overall efficiency of the image encoding unit.

### BRIEF DESCRIPTION OF THE DRAWINGS

The above and other features and advantages of the present invention will become more apparent by describing in detail exemplary embodiments thereof with reference to the attached drawings in which:

FIG. 1 shows a delay time between a motion estimation operation and operations from among multiple operations performed by an image encoding unit;

FIG. 2 is a block diagram of an example of an image encoding device;

FIG. 3 is a flowchart of a method of encoding an image; and

FIG. 4 is a flowchart of a method for performing motion estimation.

Like reference numerals in the drawings denote like elements.

### DETAILED DESCRIPTION

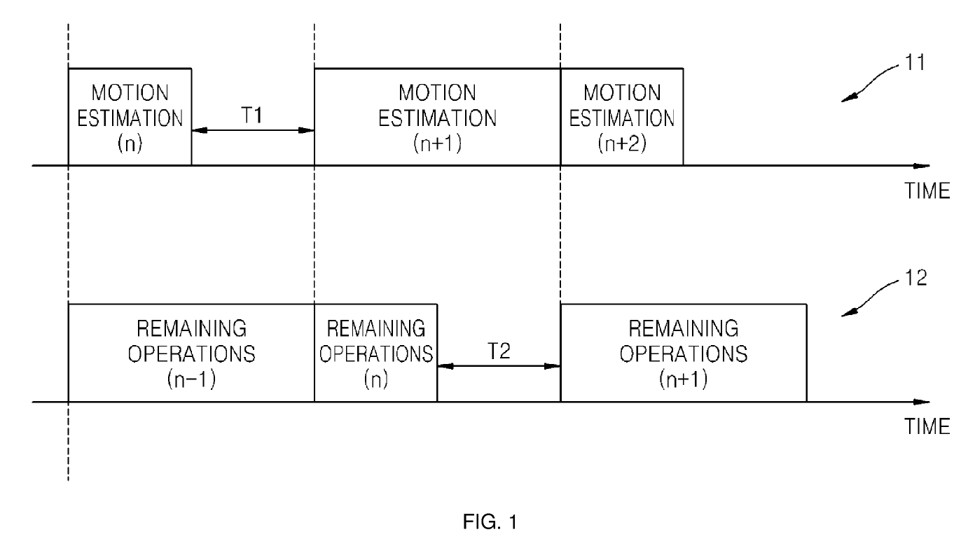

FIG. 1 shows a delay time between a motion estimation operation 11 and operations 12 from among multiple operations performed by an image encoding unit. The motion estimation operation 11 is illustrated with respect to time (x-axis) to indicate a sequence of the motion estimation operation 11 in chronological order. Also, the other operations 12 are illustrated with respect to time (x-axis) to indicate a sequence of the remaining operations in chronological order. The remaining operations can include operations other than the motion estimation operation from among the multiple operations performed by the image encoding unit. For example, the remaining operations may include a transformation operation, a quantization operation, a variable length encoding operation, an inverse quantization operation, an inverse transformation operation, a motion compensation operation, a de-blocking filtering operation or a combination therein. In FIG. 1, the variable ‘n’ indicates a natural number.

The motion estimation operation can employ block matching that compares pixel values of each of multiple blocks included within a predetermined range with pixel values of a current block. Responsive to the comparison, a block corresponding to the smallest sum of pixel value differences (e.g., the sum of absolute differences (SAD)) is detected as a reference block with respect to the current block. Therefore, motion estimation can use massive amounts of calculations. Furthermore, various algorithms may be selectively applied according to various conditions, such as a set up of a search location, a set up of a search range, a set up of the size of a block, a set up of the threshold value with respect to a sum of pixel value differences or a combination therein. Therefore, the quantity of calculations may vary significantly based on the selected algorithm.

The remaining operations other than the motion estimation operation can be performed according to predetermined algorithms. Therefore, the quantity of calculations for the remaining operations may not change, and the quantity of calculations used for the remaining operations can be relatively small. Generally, the quantity of calculations for the motion estimation operation is similar to the sum of the quantities of calculations for the remaining operations. Therefore, the motion estimation operation and the remaining operations can be performed in parallel. In other words, the motion estimation operation can be performed with respect to a current image while performing the remaining operations based on a result of the motion estimation operation performed with respect to a previous image.

For example, while the motion estimation operation is being performed with respect to the n^{th} image of a given video, the remaining operations are performed based on a result of the motion estimation operation performed with respect to the (n−1)^{th} image of the given video. However, if the remaining operations are performed for a longer period of time, the motion estimation operation with respect to the (n+1)^{th} image of the given video is performed after a first delay time T1 has elapsed from completion of the motion estimation operation with respect to the n^{th} image of the given video. In other words, the motion estimation operation with respect to the (n+1)^{th} image of the given video is performed after completion of the remaining operations with respect to the (n−1)^{th} image of the given video.

Furthermore, the remaining operations are performed based on a result of the motion estimation operation performed with respect to the n^{th} image of the given video while the motion estimation operation is performed with respect to the (n+1)^{th} image of the given video. However, if the motion estimation operation is performed for a longer period of time, the remaining operations with respect to the (n+1)^{th} image of the given video are performed after a second delay time T2 has elapsed from completion of the remaining operations with respect to the n^{th} image of the given video. In other words, the remaining operations with respect to the (n+1)^{th} image of the given video are performed after completion of the motion estimation operation with respect to the (n+1)^{th} image of the given video.

As described above, when the motion estimation operation and the remaining operations are performed in parallel, an algorithm for a motion estimation operation unit is selected, such that the total quantity of calculations of the motion estimation operating unit and the sum of the quantities of calculations for the remaining operations are similar to each other. When the same algorithm is applied to perform the motion estimation operation regardless of momentary operating status of the image encoding unit (e.g. the quantities of calculations for the remaining operations), the delay times occur due to an imbalance between the momentary quantity of calculations for the motion estimation operation and the sum of the momentary quantities of calculations for the remaining operations. As a result, the overall efficiency of the image encoding unit deteriorates.

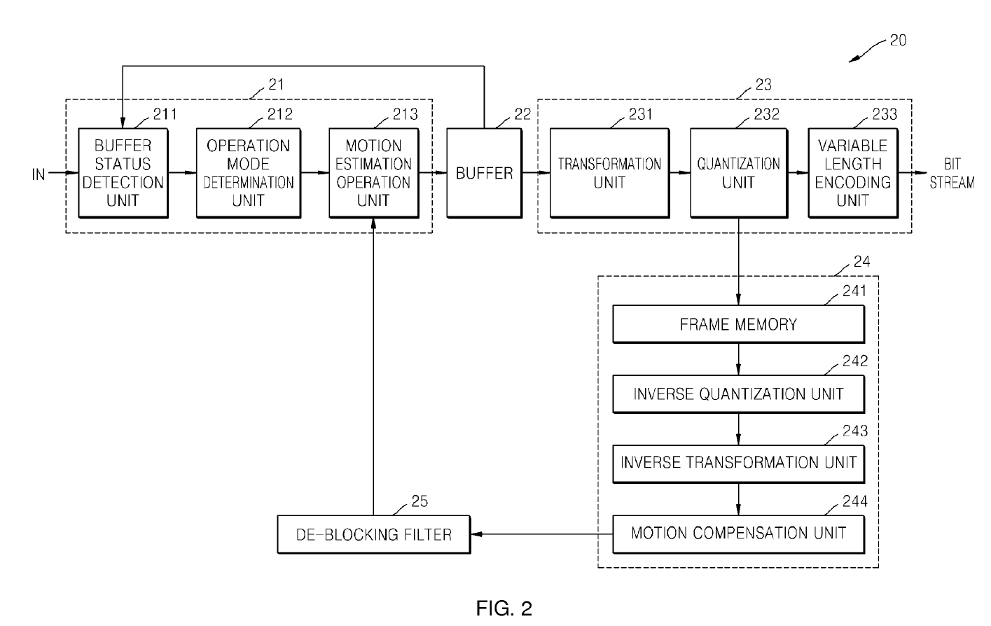

FIG. 2 is a block diagram of an image encoding device 20. The image encoding device 20 includes a motion estimation unit 21, a buffer 22, an encoding unit 23, a reconstruction unit 24, and a frame memory 25.

The motion estimation unit 21 performs motion estimation operation with respect to an input image IN of a given video. The buffer 22 buffers a result of the motion estimation operation output by the motion estimation unit 22. The encoding unit 23 encodes the result of the motion estimation operation stored in the buffer unit 22. The reconstruction unit 24 reconstructs the encoded result of the motion estimation operation. The frame memory 25 stores the reconstructed image frame-by-frame. In the example shown in FIG. 2, the operations performed by the encoding unit 23 and the reconstruction unit 24 can be described as the remaining operations described with respect to FIG. 1 above.

The motion estimation unit 21 includes a buffer status detection unit 211, an operation mode determination unit 212, and a motion estimation operation unit 213. The buffer status detection unit 211 detects the status of the buffer 22 based on a quantity of a result of the motion estimation operation stored in the buffer 22, that is, a quantity of data stored in the buffer 22. The buffer status detection unit 211 compares a quantity of data stored in the buffer unit 22 to predetermined threshold values.

For example, the buffer status detection unit 211 compares a quantity of data stored in the buffer 22 to a first threshold value TH1. When the quantity of data stored in the buffer 22 is smaller than the first threshold value TH1, the buffer status detection unit 211 compares the quantity of data stored in the buffer 22 to a second threshold value TH2, which is smaller than the first threshold value TH1. For example, the first threshold value TH1 may be ¾, and the second threshold value TH2 may be ¼. Although an example of detecting a quantity of data stored in the buffer 22 by using two threshold values is described above, the buffer status detection unit 211 may detect the status of the buffer 22 by using either one threshold value or three or more threshold values according to another embodiment.

The operation mode determination unit 212 determines an operation mode of the motion estimation operation based on the status of the buffer 22 detected by the buffer status detection unit 211. The operation mode determination unit 212 determines one of multiple algorithms, which have different algorithm complexities, based on the status of the buffer 22 as the algorithm to be applied to the motion estimation operation unit 213.

For example, when the quantity of data stored in the buffer 22 is equal to or greater than the first threshold value TH1, the quantity of calculations for the remaining operations is equal to or greater than the quantity of calculations for the motion estimation operation. Thus, the quantity of calculations for the motion estimation operation should be increased, such that the quantity of calculations for the motion estimation operation and the quantity of calculations of the remaining operations are balanced. Therefore, the operation mode determination unit 212 applies a more complex algorithm to the motion estimation operation. In other words, an operation mode applied to the motion estimation unit 213 in this example can be an operation mode having a relatively high complexity.

Furthermore, when the quantity of data stored in the buffer 22 is smaller than the second threshold value TH2, the quantity of calculations for the remaining operations is smaller than the quantity of calculations for the motion estimation operation. Thus, the quantity of calculations for the motion estimation operation should be decreased, such that the quantity of calculations for the motion estimation operation and the quantity of calculations of the remaining operations are balanced. Therefore, the operation mode determination unit 212 applies a less complex algorithm to the motion estimation operation. In other words, an operation mode applied to the motion estimation unit 213 in this example can be an operation mode having a relatively low complexity.

Furthermore, when the quantity of data stored in the buffer 22 is equal to or greater than the second threshold value TH2 and is smaller that the first threshold value TH1, the quantity of calculations for the remaining operations is normal. In other words, the quantity of calculations for the motion estimation operation and the quantity of calculations for the remaining operations are similar to each other. Therefore, the operation mode determination unit 212 applies a normal algorithm to the motion estimation operation. In other words, an operation mode applied to the motion estimation unit 213 in this example can be a normal operation mode having a normal complexity.

The motion estimation unit 213 performs the motion estimation operation with respect to a current image IN of a given video according to the operation mode determined by the operation mode determination unit 212. The motion estimation unit 213 compares the pixel values of multiple images of the given video stored in the frame memory 25 to the pixel values of the current image IN, and determines an image corresponding to the smallest SAD with respect to the current image IN as a reference image with respect to the current image IN. Additionally, the motion estimation unit 213 outputs the difference between the pixel values of the reference image and the pixel values of the current image IN (e.g., an error image) to the buffer 22 as a result of the motion estimation operation.

The encoding unit 23 includes a transformation unit 231, a quantization unit 232, and a variable length encoding unit 233. The transformation unit 231 converts a result of the motion estimation operation from the pixel domain to the frequency domain. The quantization unit 232 quantizes a result of the transformation. The variable length encoding unit 233 performs variable length encoding with respect to a result of the quantization. Here, the variable length encoding unit 233 may employ entropy encoding, which can be used to reduce the overall quantity of data by encoding frequently used codes to relatively short codes and encoding less frequently used codes to relative long codes based on the statistic probabilities of data. Examples of entropy encoding can include Huffman encoding, mathematical encoding, and Lempel-Ziv-Welch (LZW) encoding.

The reconstruction unit 24 includes an inverse quantization unit 241, an inverse transformation unit 242, a motion compensation unit 243, and a de-blocking filter 244. The inverse quantization unit 241 inversely quantizes a result of quantization performed by the quantization unit 232. The inverse transformation unit 242 inversely converts a result of the inverse quantization from the frequency domain to the pixel domain. The motion compensation unit 243 performs motion compensation with respect to a result of the inverse transformation. The de-blocking filter 244 selectively performs de-blocking filtering at a border between a block and a macro block or a border between macro blocks in a result of the motion compensation to reduce block distortion within a reconstructed image.

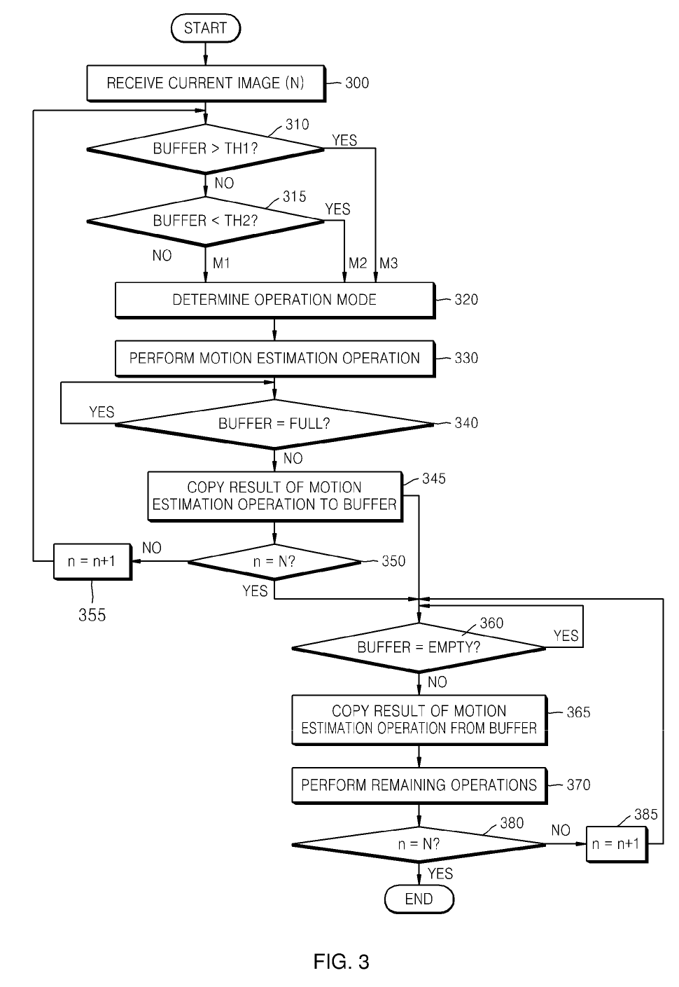

FIG. 3 is a flowchart of a method of encoding an image. The method of encoding an image includes operations that are performed in chronological order. Therefore, even if not expressly stated below, the descriptions regarding the image encoding device 20 shown in FIG. 2 apply to the method of encoding an image described with respect to FIG. 3.

At 300, a motion estimating unit 21 receives a current image, for example, the n^{th} image. As described herein, n is a natural number.

At 310, the buffer status detection unit 211 determines whether the quantity of data stored in the buffer 22 is equal to or greater than a first threshold value TH1. When determined that the quantity of data stored in the buffer 22 is equal to or greater than the first threshold value TH1, the method proceeds to operation 320; otherwise, the method proceeds to operation 315.

At 315, the buffer status detection unit 211 determines whether the quantity of data stored in the buffer 22 is equal to or greater than a second threshold value TH2. Here, the second threshold value TH2 is smaller than the first threshold value TH1.

At 320, the operation mode determination unit 212 1) determines a first operation mode M1, of which algorithm complexity is normal, as the operation mode of the motion estimation operation when the quantity of data stored in the buffer 22 is equal to or greater than the second threshold value TH2 and is smaller than the first threshold value TH1; 2) determines a second operation mode M2, of which algorithm complexity is relatively low, as the operation mode of the motion estimation operation when the quantity of data stored in the buffer 22 is smaller than the second threshold value TH2; and 3) determines a third operation mode M3, of which algorithm complexity is relatively high, as the operation mode of the motion estimation operation when the quantity of data stored in the buffer 22 is equal to or greater than the first threshold value TH1.

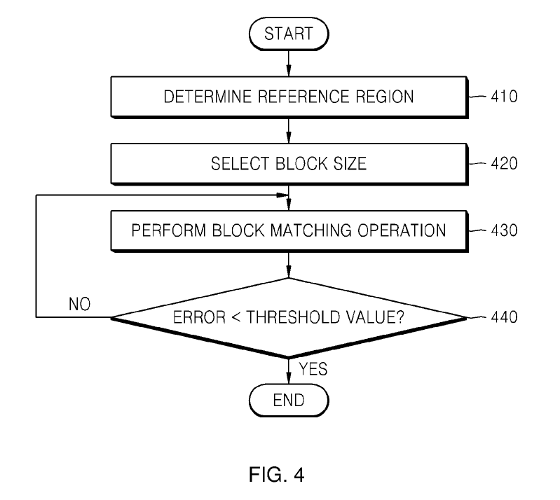

At 330, the motion estimation operation unit 213 performs the motion estimation operation with respect to the n^{th} image according to the operation mode determined at 320. In other words, the motion estimation operation unit 213 applies an algorithm according to the operation mode determined at 320 and performs the motion estimation operation. The performance of the motion estimation operation by applying an algorithm according to the operation mode thereof are described below with reference to FIG. 4.

At 340, a determination is made on whether the buffer 22 is full or not. When determined that the buffer 22 is not full, the method proceeds to operation 345. At 345, a result of the motion estimation operation is copied to the buffer 22. Otherwise, when determined that the buffer 22 is full, a result of the motion estimation operation cannot be copied to the buffer 22, and thus the method is deferred until the buffer 22 secures sufficient storage space.

At 350, a determination is made on whether the value of n is equal to N, which indicates the total number of images, where n and N are natural numbers. When determined that the value of n is not equal to N, the method proceeds to operation 355. At 355, 1 is added to the value of n, and the method is repeated from operation 310 with respect to a next image.

At 360, a determination is made on whether the buffer 22 is empty. When determined that the buffer 22 is not empty, the method proceeds to operation 365. At 365, a result of the motion estimation operation is copied from the buffer 22. Otherwise, when the buffer 22 is empty, a result of the motion estimation operation cannot be copied from the buffer 22, and thus the method is deferred until a result of the motion estimation operation is copied to the buffer 22.

At 370, the encoding unit 23 and the reconstruction unit 24 perform the remaining operations. Here, the remaining operations may refer to a transformation operation, a quantization operation, a variable length encoding operation, an inverse quantization operation, an inverse transformation operation, a motion compensation operation, a de-blocking filtering operation or a combination therein, with respect to a result of the motion estimation operation.

At 380, a determination is made on whether the value of n is equal to N, which indicates the total number of images. When determined that the value of n is not equal to N, the method proceeds to operation 385. At 385, 1 is added to the value of n, and the method is repeated from operation 360 with respect to a next image.

As described above, the motion estimation operation and the remaining operations are performed in parallel. In some implementations, the motion estimation operation and the transformation operation may be performed in parallel with operations other than the motion estimation operation and the transformation operation. In this case, the quantity of calculations for the operations other than the motion estimation operation and the transformation operation may be determined by detecting the quantity of data, which is stored in an output buffer of the transformation operation. Additionally, operation modes of the motion estimation operation and the transformation operation may be adaptively changed based on the determined quantity of calculations for the operations other than the motion estimation operation and the transformation operation.

In some implementations, the motion estimation operation and a first operation may be performed in parallel with operations other than the motion estimation operation and the first operation. In this case, the quantity of calculations for the operations other than the motion estimation operation and the first operation may be determined by detecting the quantity of data, which is stored in an output buffer of the first operation. Additionally, operation modes of the motion estimation operation and the first operation may be adaptively changed based on the determined quantity of calculations for the operations other than the motion estimation operation and the first operation.

FIG. 4 is a flowchart of a method for performing a motion estimation operation. Referring to FIG. 4, the method for performing the motion estimation operation, according to the present embodiment, includes operations that are performed by the motion estimation operation unit 213 of the image encoding device 20 shown in FIG. 2 in chronological order. Therefore, even if not expressly described below, the descriptions regarding the motion estimation operation unit 213 apply to the method for performing the motion estimation operation.

At 410, the motion estimation operation unit 213 determines a reference region for the motion estimation operation. At 420, the motion estimation operation unit 213 selects a size of a block used for the motion estimation operation. At 430, the motion estimation operation unit 213 performs a block matching operation and calculates a sum of differences between the pixel values of each of the pixels included in a reference block included in the reference region determined at 410 and the pixel values of each of the pixels in a current block as an error. At 440, the motion estimation operation unit 213 determines whether the error calculated at 430 is smaller than a threshold value. When determined that the error is not smaller than the threshold value, operation 430 is repeated. Here, operations 430 and 440 are performed in the entire reference region determined at 410 with respect to each of the blocks whose sizes are selected at 420. When the error is smaller than the threshold value, the method is terminated.

Additionally, a method for performing the motion estimation operation according to an operation mode determined by the operation mode determination unit 212 is described. For example, an operation mode determined by the operation mode determination unit 212 can be a first operation mode M1 associated with a normal algorithm. For the first operation mode M1, the following can be performed.

At 410, the motion estimation operation unit 213 determines a block of a size 32×32 pixels as a reference region in which a starting location of the reference region corresponds to coordinate (0, 0) of an image, picture or frame. The block size of 32×32 is presented merely as an example, and the size of the reference region may be determined to be larger or smaller in other implementations.

At 420, the motion estimation operation unit 213 selects 16×16 and 8×8 as sizes of blocks used for the motion estimation operation. The block sizes of 16×16 and 8×8 are presented merely as examples, and the sizes of the blocks may be determined to be larger or smaller in other implementations.

At 430, the motion estimation operation unit 213 performs a block matching operation with respect to reference blocks included in the reference region and a current block, and responsive to the block matching, the motion estimation operation unit 213 can generate an error indication as appropriate. At 440, the motion estimation operation unit 213 determines whether the error indication generated at 430 is smaller than a threshold value. When determined that the error indication is not smaller than the threshold value, operation 430 is repeated. The threshold value may be substantially 1,000, for example.

In another example, an operation mode determined by the operation mode determination unit 212 can be a second operation mode M2 associated with a less complex algorithm than a normal algorithm. For the second operation mode M2, the following can be performed.

At 410, the motion estimation operation unit 213 determines a block of a size 16×16 as a reference region based on a motion vector location of a block adjacent to a current block. Accordingly, in the second operation mode M2, the starting location of the reference region is not far from the current block, and the reference region is smaller than that of the first operation mode M1. Thus, the quantity of calculations for the motion estimation operation is smaller than that of the first operation mode M1.

At 420, the motion estimation operation unit 213 selects 16×16 and 8×8 as sizes of blocks used for the motion estimation operation. At 430, the motion estimation operation unit 213 performs a block matching operation with respect to reference blocks included in the reference region and the current block, and responsive to the block matching, the motion estimation operation unit 213 can generates an error indication as appropriate. Because the size of the reference region in the second operation mode M2 is smaller than for the first operation mode M1, a fewer number of reference blocks are included in the reference region in the second operation mode M2 as compared to the first operation mode M1. Therefore, the block matching operation is performed for a fewer number of times in the second operation mode M2 than for the first operation mode M1, and thus the quantity of calculations for the motion estimation operation in the second operation mode M2 is smaller than for the first operation mode M1.

At 440, the motion estimation operation unit 213 determines whether the error generated at 430 is smaller than a threshold value. When determined that the error is not smaller than the threshold value, operation 430 is repeated. The threshold value may be substantially 1,500, for example. As a result, the error indication is generally not smaller than the threshold value, and thus the number of times the block matching operation is performed is reduced. Therefore, the quantity of calculations for the motion estimation operation is reduced.

In yet another example, an operation mode determined by the operation mode determination unit 212 can be a third operation mode M3 associated with a highly complex algorithm (e.g., more complex than the normal algorithm in the first operation mode). For the third operation mode M3, the following can be performed.

At 410, the motion estimation operation unit 213 determines a block of a size 32×32 as a reference region in which a starting location of the reference region corresponds to coordinate (0, 0) of an image, picture or frame. At 420, the motion estimation operation unit 213 selects 16×16, 8×8, 16×8, and 8×16 as sizes of blocks used for the motion estimation operation. Block matching operations are performed using each of these four block sizes selected in the third operation mode M3, and thus the quantity of calculations for the motion estimation operation is greater than for the first operation mode M1.

At 430, the motion estimation operation unit 213 performs a block matching operation with respect to reference blocks included in the reference region and the current block, responsive to the block matching, the motion estimation operation unit 213 can generates an error indication as appropriate. At 440, the motion estimation operation unit 213 determines whether the error indication generated at 430 is smaller than a threshold value. When determined that the error indication is not smaller than the threshold value, operation 430 is repeated. The threshold value may be substantially 800, for example. As a result, the error is generally smaller than the threshold value, and thus the number of times the block matching operation is performed increases. Therefore, the quantity of calculations for the motion estimation operation in the third operation mode M3 is greater than for the first operation mode M1.

As described herein, an operation mode of a motion estimation operation can be adaptively determined according to an operating status of an image encoding unit, in particular, according to the quantities of calculations for remaining operations other than the motion estimation operation. Therefore, the quantities of calculations between the motion estimation operation and the remaining operations may be uniformly distributed. Accordingly, the delay times may not occur when the motion estimation operation and the remaining operations are performed in parallel, and the overall efficiency of the image encoding unit may be enhanced.

While this specification contains many specifics, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments.

Only a few implementations and examples are described and other implementations, enhancements and variations can be made based on what is described and illustrated in this application. For example the term, image, can be interchangeably used with the term, picture or frame. Also, the described image encoding techniques, apparatus and systems can be implemented as computer readable instructions or codes embodies on a computer readable recording or storage medium. The computer readable recording medium can include any data storage device that can store data which can be thereafter be read by a computer system. Examples of the computer readable recording medium can include read-only memory (ROM), random-access memory (RAM), CD-ROMs, magnetic tapes, floppy disks, optical data storage devices, etc. The computer readable recording medium can also be distributed over network coupled computer systems so that the computer readable code is stored and executed in a distributed fashion.

What is claimed is:

1. A method performed by an encoding device to encode a video, the method comprising:
sequentially performing a motion estimation operation and an encoding operation comprising:
determining an operation mode of the motion estimation operation based on a quantity of calculations for the encoding operation;
performing the motion estimation operation with respect to an image of the video based on the determined operation mode; and
performing the encoding operation based on a result of the motion estimation operation.

2. The method of claim 1, wherein the operation mode of the motion estimation operation is adaptively determined from among a plurality of different operation modes corresponding to different complexities of the motion estimation operation based on the quantity of calculations for the encoding operation.

3. The method of claim 1, further comprising buffering the result of the motion estimation operation,
wherein the encoding operation is performed based on the buffered result of the motion estimation operation.

4. The method of claim 3, wherein determining the operation mode comprises:
determining the quantity of calculations for the encoding operation based on a quantity of the buffered result of the motion estimation operation; and
adaptively selecting the operation mode from among a plurality of different operation modes based on a complexity of the motion estimation operation.

5. The method of claim 4, wherein determining the quantity of calculations for the encoding operation based on the quantity of the buffered result of the motion estimation operation comprises:
determining whether the quantity of the buffered result of the motion estimation operation is equal to or greater than a first threshold value; and
when determined that the quantity of the buffered result of the motion estimation operation is smaller than the first threshold value, determining whether the quantity of the buffered result of the motion estimation operation is smaller than or equal to a second threshold value,
wherein the second threshold value is smaller than the first threshold value.

6. The method of claim 5, wherein adaptively determining the operation mode comprises:
selecting a first operation mode from the plurality of different operation modes as the operation mode of the motion estimation operation when the quantity of the buffered result of the motion estimation operation is equal to or greater than the second threshold value and is smaller than the first threshold value;
selecting a second operation mode from the plurality of different operation modes as the operation mode of the motion estimation operation when the quantity of the buffered result of the motion estimation operation is smaller than the second threshold value; and
selecting a third operation mode from the plurality of different operation modes as the operation mode of the motion estimation operation when the quantity of the buffered result of the motion estimation operation is equal to or greater than the first threshold value,
wherein the complexity of the motion estimation operation in the first operation mode is higher than the complexity of the motion estimation operation in the second operation mode and lower than the complexity of the motion estimation operation in the third operation mode.

7. The method of claim 1, wherein the encoding operation is performed with respect to a previous image of the video while the motion estimation operation is performed with respect to a current image of the video in parallel.

8. An image encoding device comprising:
a motion estimation unit to perform a motion estimation operation with respect to an image in a given video; and
an encoding unit to perform an encoding operation based on a result of the motion estimation operation,
wherein the motion estimation unit determines an operation mode of the motion estimation unit based on a quantity of calculations performed by the encoding unit during the encoding operation and performs the motion estimation operation with respect to the image according to the determined operation mode.

9. The image encoding device of claim 8, wherein the motion estimation unit adaptively determines the operation mode from among a plurality of different operation modes based on a complexity of the motion estimation operation.

10. The image encoding device of claim 8, further comprising a buffer for temporarily storing a result of the motion estimation operation,
wherein the encoding unit performs the encoding operation based on the buffered result of the motion estimation operation.

11. The image encoding device of claim 10, wherein the motion estimation unit comprises:
a buffer status detection unit to determine the quantity of calculations performed by the encoding unit during the encoding operation based on a quantity of data stored in the buffer;
an operation mode determining unit to adaptively determine the operation mode from among a plurality of different operation modes based on the complexity of the motion estimation operation; and
a motion estimation operation unit to perform the motion estimation operation with respect to the image according to the determined operation mode.

12. The image encoding device of claim 11, wherein the buffer status detection unit determines whether the quantity of the data stored in the buffer is equal to or greater than a first threshold value or not; and
when determined that the quantity of data stored in the buffer is equal to or greater than the first threshold number, the buffer status detection unit determines whether the quantity of data stored in the buffer is equal to or greater than a second threshold value, wherein the second threshold value is smaller than the first threshold value.

13. The image encoding device of claim 12, wherein the operation mode determination unit selects a first operation mode from the plurality of different operation modes as the operation mode of the motion estimation operation when the quantity of data stored in the buffer is equal to or greater than the second threshold value and is smaller than the first threshold value;
the operation mode determination unit determines a second operation mode from the plurality of different operation modes as the operation mode of the motion estimation operation when the quantity of data stored in the buffer is smaller than the second threshold value; and
the operation mode determination unit determines a third operation mode from the plurality of different operation modes as the operation mode of the motion estimation operation when the quantity of data stored in the buffer is equal to or greater than the first threshold value;
wherein the complexity of the motion estimation operation in the first operation mode is higher than the complexity of the motion estimation operation in the second operation mode and lower than the complexity of the motion estimation operation in the third operation mode.

14. The image encoding device of claim 8, wherein the encoding unit performs the encoding operation with respect to a previous image of the given video while the motion estimation unit performs the motion estimation operation with respect to a current image of the given video in parallel.

15. A computer readable storage medium embodying instructions to cause a data processing apparatus to encode a video, comprising:
sequentially performing a motion estimation operation and an encoding operation, comprising:
determining an operation mode of the motion estimation operation based on a quantity of calculations for the encoding operation;
performing the motion estimation operation with respect to an image in the video according to the determined operation mode; and
performing the encoding operation with respect to a result of the motion estimation operation.

16. The computer readable storage medium of claim 15, wherein the operation mode of the motion estimation operation is adaptively determined from among a plurality of different operation modes corresponding to different complexities of the motion estimation operation based on the quantity of calculations for the encoding operation.

17. The computer readable recording storage medium of claim 15, further operable to cause the data processing apparatus to perform operations comprising:
buffering the result of the motion estimation operation, wherein the encoding operation is performed based on the buffered result of the motion estimation operation.

18. The computer readable recording storage medium of claim 17, wherein determining the operation mode comprises:
determining the quantity of calculations for the encoding operation based on a quantity of the buffered result of the motion estimation operation; and
adaptively selecting the operation mode from among a plurality of different operation modes based on a complexity of the motion estimation operation.

19. The computer readable recording storage medium of claim 18, wherein determining the quantity of calculations for the encoding operation based on the quantity of the buffered result of the motion estimation operation comprises:
determining whether the quantity of the buffered result of the motion estimation operation is equal to or greater than a first threshold value; and
when determined that the quantity of the buffered result of the motion estimation operation is smaller than the first threshold value, determining whether the quantity of the buffered result of the motion estimation operation is smaller than or equal to a second threshold value, wherein the second threshold value is smaller than the first threshold value.

20. The computer readable recording storage medium of claim 19, wherein adaptively determining the operation mode comprises:
selecting a first operation mode from the plurality of different operation modes as the operation mode of the motion estimation operation when the quantity of the buffered result of the motion estimation operation is equal to or greater than the second threshold value and is smaller than the first threshold value;
selecting a second operation mode from the plurality of different operation modes as the operation mode of the motion estimation operation when the quantity of the buffered result of the motion estimation operation is smaller than the second threshold value; and
selecting a third operation mode from the plurality of different operation modes as the operation mode of the motion estimation operation when the quantity of the buffered result of the motion estimation operation is equal to or greater than the first threshold value;
wherein the complexity of the motion estimation operation in the first operation mode is higher than the complexity of the motion estimation operation in the second operation mode and lower than the complexity of the motion estimation operation in the third operation mode.
